(19) United States
(12) Patent Application Publication
(10) Pub. No.: US 2015/0024168 A1
(43) Pub. Date: Jan. 22, 2015

(54) MODEL OF WARM STONE FLOOR MATERIAL

(71) Applicant: Yu-Sung Son, Nanan (CN)

(72) Inventor: Yu-Sung Son, Nanan (CN)

(73) Assignee: SKALA STONE, INC., Boca Raton, FL (US)

(21) Appl. No.: 13/578,467

(22) PCT Filed: Apr. 24, 2012
(86) PCT No.: PCT/KR2012/003151

§ 371 Date: Aug. 10, 2012

(30) Foreign Application Priority Data
Nov. 4, 2011 (CN) 2011204369163

(51) Int. Cl. E04B 5/48; E04F 15/04; E04F 15/08; B32B 5/02; B32B 38/10; B32B 21/04; B32B 3/06; B32B 3/30; B32B 38/00; E04F 15/02; B32B 9/00

(52) U.S. Cl. CPC E04B 5/48; E04F 15/02038; E04F 15/041; E04F 15/082; B32B 5/028; B32B 9/002; B32B 21/04; B32B 3/06; B32B 3/30; B32B 38/0004; B32B 38/10; B32B 2250/04; B32B 2250/05; B32B 2305/08; B32B 2305/38; B32B 2419/04
USPC 428/172; 442/1; 428/192; 156/256

(57) ABSTRACT

The present invention comprises an engineered architectural material suitable for flooring or cladding walls which is capable of withstanding heat and humidity and methods of manufacturing thereof The architectural material of the present invention is particularly suited for use with natural stone veneers and when constructed in accordance with the present invention such flooring is resistant to cracking and delamination. An embodiment of the invention further comprises an integrated electric resistance heater embedded in the material.

This application claims priority to and is a continuation-in-part of PCT application PCT/KR2012/003151 filed on Apr. 24, 2012 which is a PCT application of Chinese patent application CN2011204369163 filed on Apr. 11, 2011.

### FIELD OF THE INVENTION

This invention is about an engineered flooring which is capable of withstanding heat and humidity and methods of manufacturing thereof Flooring of the present invention is particularly suited for use with natural stone veneers and when constructed in accordance with the present invention such flooring is resistant to cracking and delamination. One embodiment of the invention integrates a radiant heat source to provide heated floors.

### BACKGROUND OF THE INVENTION

Natural stone flooring is a product for which there is high demand because of its beauty and resistance to wear. However, natural stone flooring is expensive to install due to both the cost of the stone and the need for highly skilled labor for installation.

Existing stone flooring materials for interior use has a weakness in that most of it is heavy and difficult to install. Generally, in order to make stone flooring material durable, it must be reasonably thick to resist cracking. However, as thickness increases, so does weight and expense. Traditionally, stone is difficult to and requires concrete, mortar or mastics when attaching it to floors or walls. Such methods, particularly when installed on vertical surfaces is not only inconvenient during construction but often lack strength.

The art has attempted to create flooring comprising stone veneers, however such products have been unsuccessful in the market place due to cracking of the stone. Such materials when available use relatively thick layers of stone negating all or most of the cost savings usually found with veneered products.

U.S. Pat. No. 7,442,423 to Robert J. Miller teaches a hard surface veneer engineered tile. The design of Miller suffers in that the tiles are not sufficiently rigid or dimensionally stable which leads to unsightly cracking of the veneer. Such tiles have never been sold commercially due to these problems. In a tongue and groove system such as Miller, such tiles are very difficult to replace.

Heated floors are generally a very complex project involving separate installation of the heating system under traditional tile floors. Such systems generally rely on circulation of heated water through the floors but may also use an electric heating grid. When installing conventional systems, the heating system has to be installed first followed by the flooring. Such systems typically require multiple days to install. Such heating systems while they have worked well on conventional tile and stone floors laid atop a bed of mud, have had limited application when applied to composite stone flooring due to cracking or warping of tiles in the presence of heat. No suitable composite stone flooring material is known that will withstand repeated cycles of heating without damage to the floor.

### SUMMARY OF THE PRESENT INVENTION

It is an object of the present invention to provide a cost effective natural architectural materials which are easy to install on walls and floors.

It is an object of the present invention to provide a new model of heated floor material that assembling is easy to install.

It is an object of the present invention to create architectural materials which remain stable and crack free through temperature extremes.

It is an object of the invention to create a composite stone flooring using very thin veneers of stone.

The heated flooring of the present invention provides a flooring tile which is resistant to temperature and humidity changes. These characteristics make it ideal for a radiant heated floor.

The present invention, by engineering the tile out of multiple layers of materials, has created a rigid and stable substrate which is ideal for facing with natural stone. Because very thin veneers are used, the overall manufacturing cost is reduced. The final product provides significantly superior strength, shock absorption, and damage prevention profiles over existing traditional stone flooring products. Additionally, it provides reduced installation cost and time. An embodiment incorporating resistance heating coils within the layered construction eliminates the need to integrate a boiler system, including tubes for circulating heated water within the flooring and for the need to custom design a electric resistance system for each room.

In a preferred embodiment the flooring contains tongue and groove style click-to-lock construction, which eliminates the use of adhesives during installation and facilitates easy installation, providing significant installation cost and time savings.

### DESCRIPTION OF THE FIGURES

FIG. 1 is a three-dimensional diagram of the architectural material according to the invention.

FIG. 2 is a drawing of cross section structure architectural material according to the invention.

FIG. 3 is a cross section of a plate showing the tongue and groove arrangement

FIG. 4 is a cross section of the groove according to the invention.

FIG. 5 is a cross section of the tongue according to the invention.

FIGS. 6a and 6b are top and bottom perspectives of the architectural material according to the invention.

FIG. 6c is a view of the tongue side of the architectural material according to the invention.

FIG. 6d is a view of the groove side of the architectural material according to the invention.

FIGS. 7a and b are an exploded of the architectural material showing the placement of a heating element according to the invention.

FIG. 7c is a view of the back of a complete floor tile.

FIG. 7d is a close up showing the connector for the heating element.

FIG. 8 is a diagram showing a method of manufacturing the invention.

### DETAILED DESCRIPTION OF THE INVENTION

The present invention by engineering the tile out of multiple materials has created a rigid and stable substrate which is ideal for facing with natural stone. Because very thin veneers are used, the overall manufacturing cost is reduced. The final product provides significantly superior strength, shock absorption, and damage prevention profiles over existing traditional stone flooring products. Additionally, it provides reduced installation cost and time. An embodiment incorporating resistance heating coils within the layered construction eliminates the need to integrate a boiler system, including tubes for circulating heated water within the flooring and for the need to custom design a electric resistance system for each room.

In a preferred embodiment the flooring contains tongue and groove style click-to-lock construction, which eliminates the use of adhesives during installation and facilitates easy installation, providing significant installation cost and time savings.

### Example 1

### Composite Architectural Panels

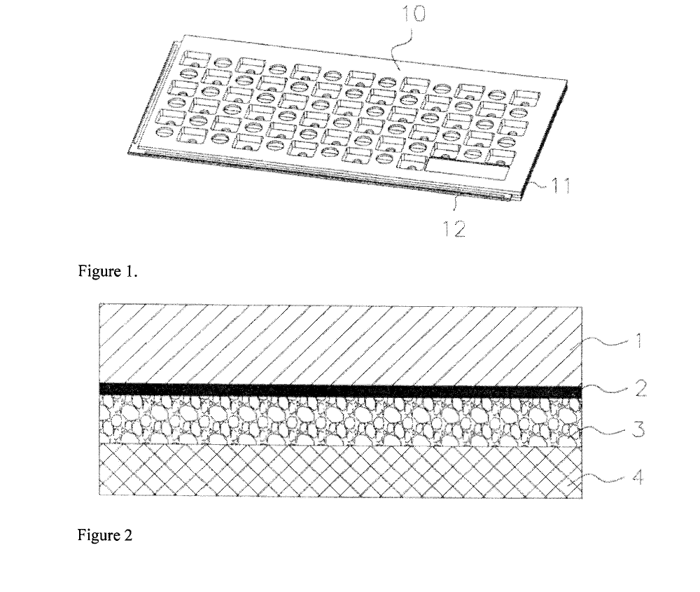

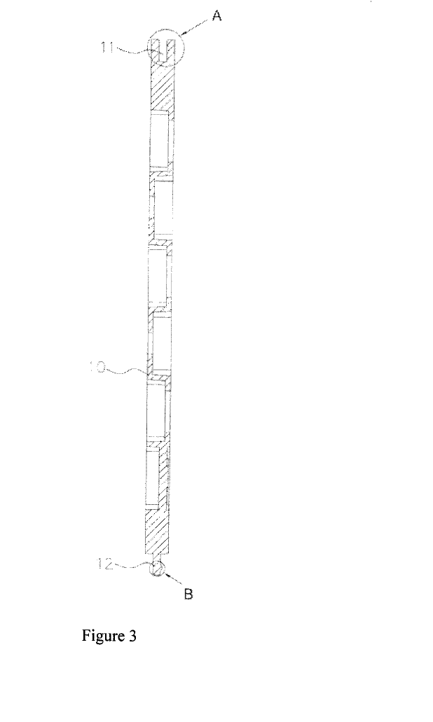

Referring to FIGS. 1-3, in an embodiment the architectural panel 10 consists of a composite constructed from 4 different materials which are layered. The top layer 1 is a rectangular, veneer of flooring surface of approximately 2.5 mm thickness. The second layer, is a mesh 2 of approximately 0.3 mm in thickness which is attached to the top layer 1 with an adhesive (not shown) to reinforce the top layer 1 and provide protection against shattering. The third layer, a resilient sheet 3, comprises a resilient backer board about 4 mm thick such an Ecoboard or a cement board, which is attached to the second layer 2 with an adhesive (not shown). The fourth layer which comprises a rigid plastic layer 4 with a unique tongue 12 and groove 11 joint structure is attached to the third layer with adhesive.

In a preferred embodiment the top layer 1 is a natural material such as stone, cork or wood. In a most preferred embodiment the material is marble. In a preferred embodiment the mesh layer 2 is preferably an aluminum mesh, although other metals or plastics can be used. The rigid plastic layer 4 is preferably a 3.5 mm thick thermal enhanced, injection molded plastic sheet, comprising a composite of polystyrene (PS), polyphenylene sulfide (PPS), polyamide (PA), Acrylonitrile butadiene styrene (ABS) and powdered charcoal, which is designed to prevent heat distortion, contraction, and expansion as well as provide shock absorption.

The choice of plastic is very important in achieving a workable composite which will resist warping, cracking or unnecessary flexing. Polystrene has great thermal resistance, but is extremely stiff increasing the likelihood of cracking. Polypropylene (PP) was also tested but found to lack the desired properties. ABS plastics were suitable.

The plastic layer 4 can be a material of uniform thickness with no gaps, holes, spaces or patterns in it. In a preferred embodiment the plastic layer 4 is patterned. The design of the plastic layer 4 is dependent in part on the plastics used in its manufacture. In one embodiment the bottom of the plastic layer 4 contains a plurality of air spaces. In one design the bottom side of the plastic layer 4 is molded to include a plurality of supportive structures 40 in which the center of the structure contains a hollow airspace 41. The airspace could be any shape, such as, but not limited to hexagons, octagons, squares, circles, rectangles, triangles or any closed geometric shape. The air space can be open to the bottom or could be closed. The airspace 41 serves to further insulate the floor, reduce the materials required for manufacturing the plastic layer and reduce the weight. In another embodiment, the plastic layer 4 is molded to omit the airspace in the center of the supportive structures. In such an embodiment the bottom surface of plastic layer 4 could be smooth or contain a plurality of solid support structures of any shape spaced in any fashion which would allow support of the floor.

Along two adjacent edges, the plastic layer 4 has a plurality of rectangular tongues 12, that protrudes beyond the edges of the other three layers. The tongues 12 have a convex raised projection 14 at the distal end. Each of the other two adjacent edges of the plastic layer are slotted or grooved 11 to accommodate the insertion of and click-locking with tongues 12 of other panels 1. Each groove 11 contains concave indentations 13 which are placed to coordinate with the convex projection 14 on the tongue. By inserting tongue 12 of one tile 10 into groove 11 of a second tile 10, the convex raised projection fits into the concave indentation thereby locking the two parts together. This tongue and groove, clicklocking system enables continuous installation of prefabricated flooring panels without usage of adhesives.

Adhesives used to join the layers of the present flooring system together can be any suitable adhesive for joining the layers including but not limited to epoxies, polyurethanes, and methacrylics. The same or different adhesives can be used to bond each layer together. It is preferred that the adhesive be waterproof or at least water resistant and not melt or release at ambient temperatures between −20 and 100 degrees F.

### Example 2

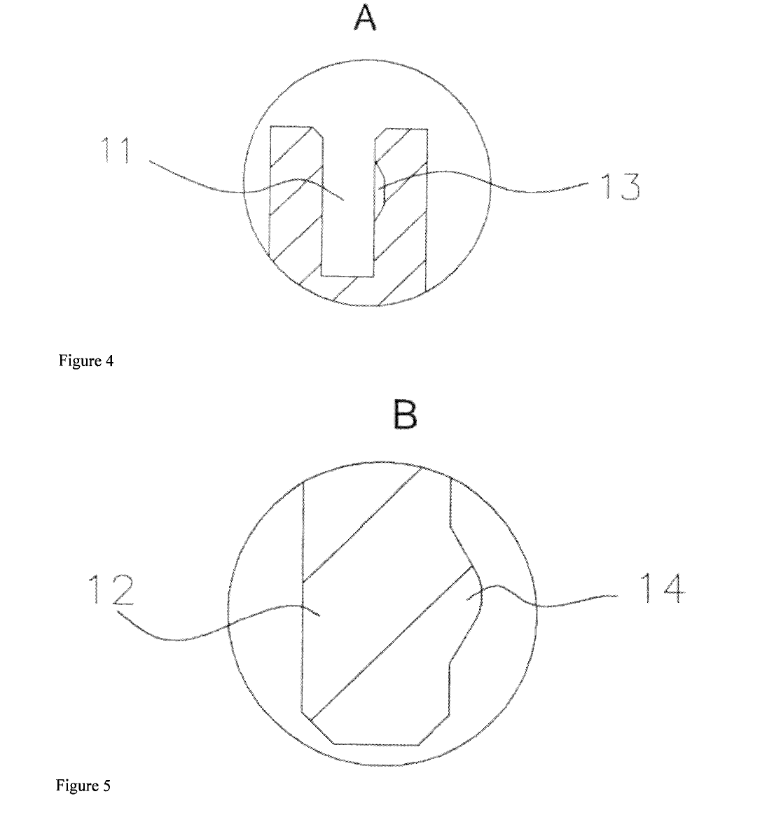

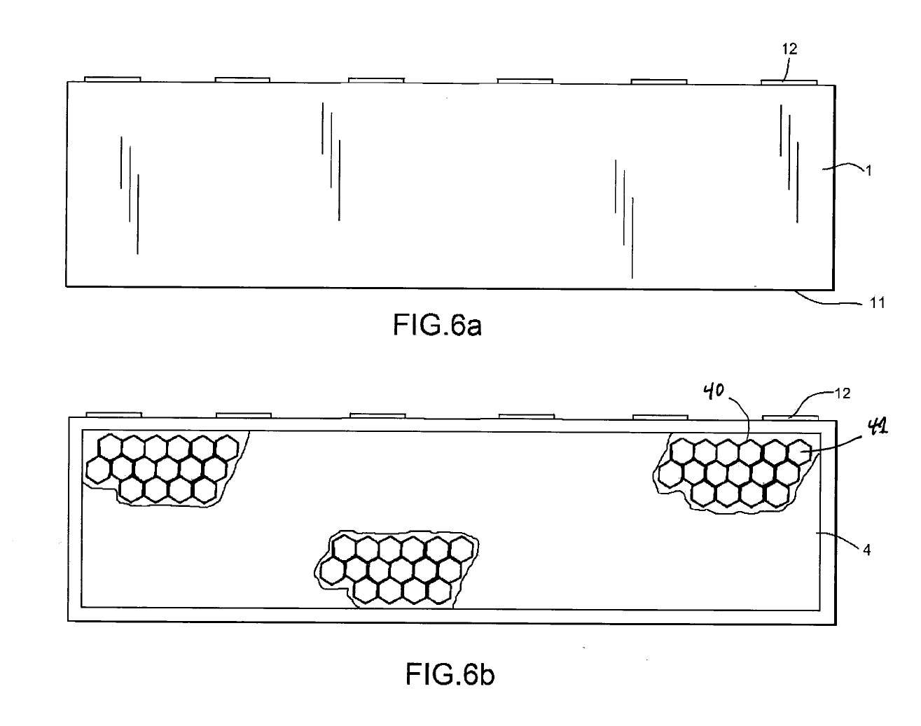

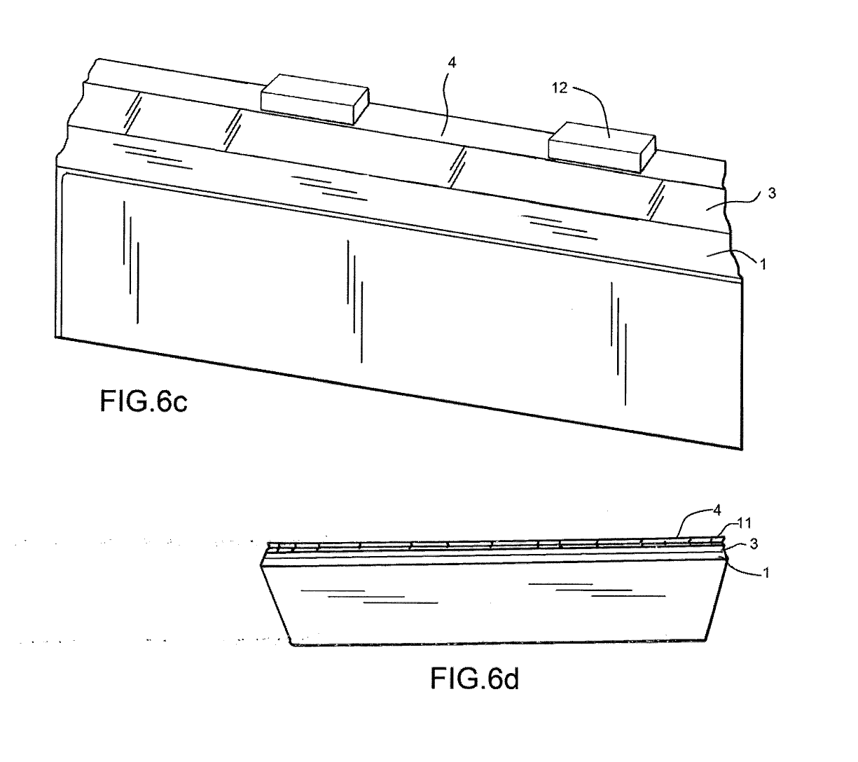

Referring to FIGS. 1-4 the stone floor material according to the invention includes all-in-one plate body 10. The plate body 10 is made up of four-layered structure, and the top layer is a marble 1, and the second layer is a metal mesh 2. The metal mesh 2 can be an aluminum mesh, a steel mesh, a stainless steel mesh and so on, and the third layer is a cement plate 3, which is preferably selected from Cellulose Reinforced Cement (“CRC”) and ECOBOARD (ECOBOARD is a multidirectional fiber board made from agricultural byproducts instead of wood and the fourth layer is a base plate 4 of made of plastic selected from plastics such as ABS (acrylonitrile, butadiene styrene), HIPS (high impact polystyrene sheet), PP (polypropylene) or other suitable polymers known in the art.

The composite plate body is formed by bonding the four layers with a. suitable bonding agent. Along two adjacent edges, the plastic layer 4 has a plurality of rectangular tongues 12, that protrudes beyond the edges of the other three layers. The tongues 12 have a convex raised projection 14 at the distal end. Each of the other two adjacent edges of the plastic layer without tongues are slotted or grooved 11 to accommodate the insertion of and click-locking with tongues 12 of other panels 1. The groove 11 and the tongue 12 are generally about equal each other in size and provide at tight fit. Each groove 11 contains concave indentations 13 which are placed to coordinate with the convex raised projection 14 on the tongue. By inserting tongue 12 of one tile 10 into groove 11 of a second tile 10, the convex raised projection fits into the concave indentation thereby locking the two parts together. This tongue and groove, clicklocking system enables continuous installation of prefabricated flooring panels without usage of adhesives. One of skill in the art will appreciate that tongues 12 and grooves 11 can be placed on the same sides of a plate 10 and designed to coordinate with each other without taking away from the spirit of the invention.

As showed in a graphic form in FIGS. 1 to 5, the new model of warmable stone floor material is formed as an all-in-one plate body 10. Multiple tiles are interlocked to form a floor. In two adjacent plate bodies 10, the interlocking tongue 12 is interlocked to the inside of the groove 11 by inserting the tongue 12 into the groove 11. The at the same time the convex edge 14 in the groove 11 is also interlocked into the concave indentation 13 on tongue 12. By interlocking every two adjacent plate bodies (10), the plates are fixed in position. Such all-in-one plate body 10 is mainly used in covering a warm stone floor. Andy desired size or shape can be assembled by combining multiple plate bodies 10. Such floors are light, easy to construct and convenient because the floor does not need to be set in mortar. When properly locked together the floor is strong and remains in place and is resistant to the effects of heat expansion or heat contraction.

### Example 3

### Heated Composite Flooring

The architectural panels of Example 1 can readily be heated by incorporating a heating element within the composite layers.

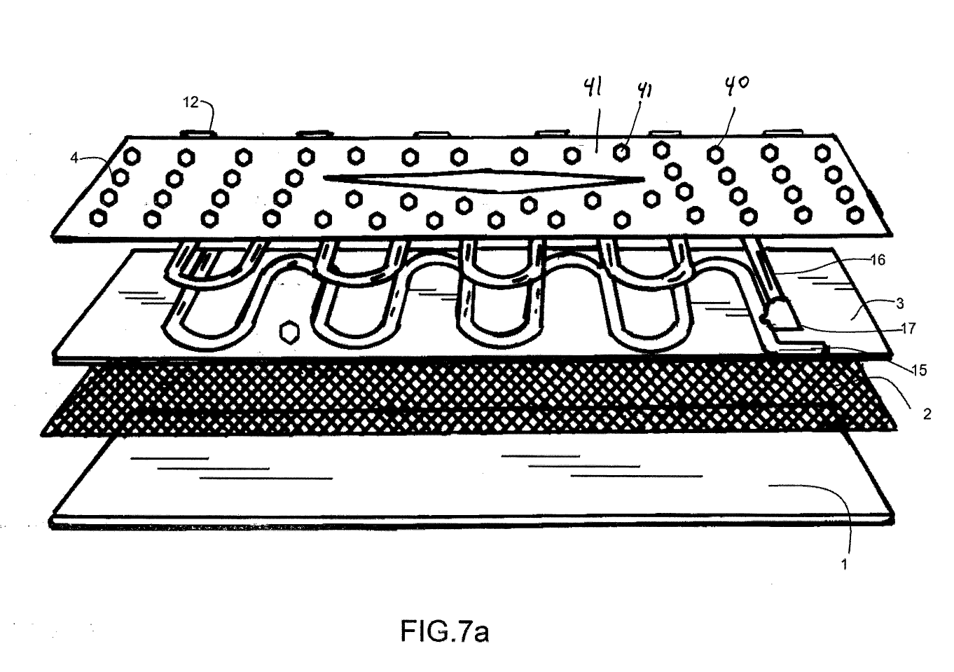

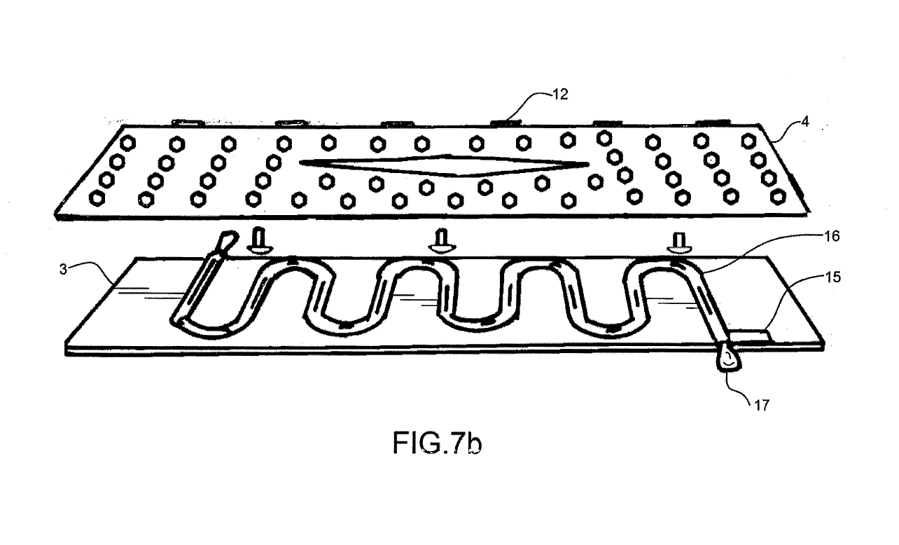

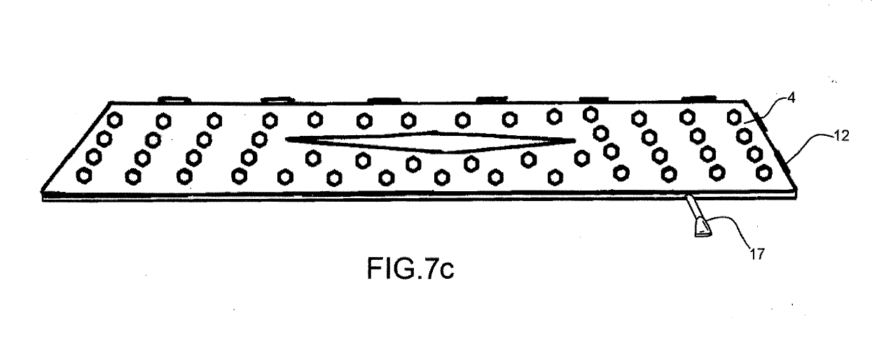

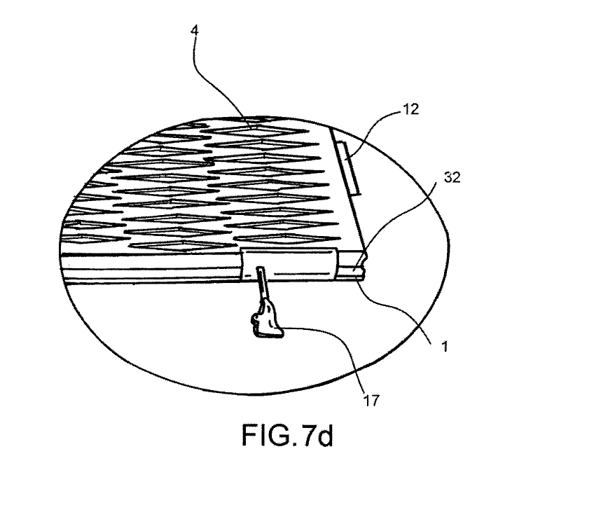

Referring to FIGS. 7a and 7b and 7c and 7d, heated floor tiles can be constructed by creating a groove 15 in the bottom of resilient layer 3 and placing a resistance heating element 16 into the groove 15 prior to bonding plastic base 4. A connector 17 is provided for attaching adjacent tiles together and to a source of electricity. The connectors may be male and female connectors or any connector design which allows adequate electrical contact. Optionally, any gaps where the connector exits the floor tile can be filed with a plug 32. The heat output from the floor can be controlled with a thermostatic controller which either senses room or floor temperature.

The groove 15 can take any pattern, but a serpentine pattern which starts and ends close from edge to edge is preferred to provide adequate heat. In areas where more heating is desired the heating elements can be spaced closer together. The heating element 16 is secured in the groove using suitable adhesives or tape.

The heating element 16 should be sized to fit the groove 15. In a preferred embodiment the heating element 16 comprises heating cord or cable. Such cords or cable are known in the art and comprise a resistance wire, preferably coated with one or more thermal and/or electrically insulating layers. The cable should be chosen such that the maximum temperature will not exceed the melting point of any of the materials in the tile. Ideally, the floor temperature will not exceed 100 degrees Fahrenheit when used with a thermostatic controller.

### Example 4

### Manufacturing

Flooring tile of the present invention can be constructed in accordance with the following example.

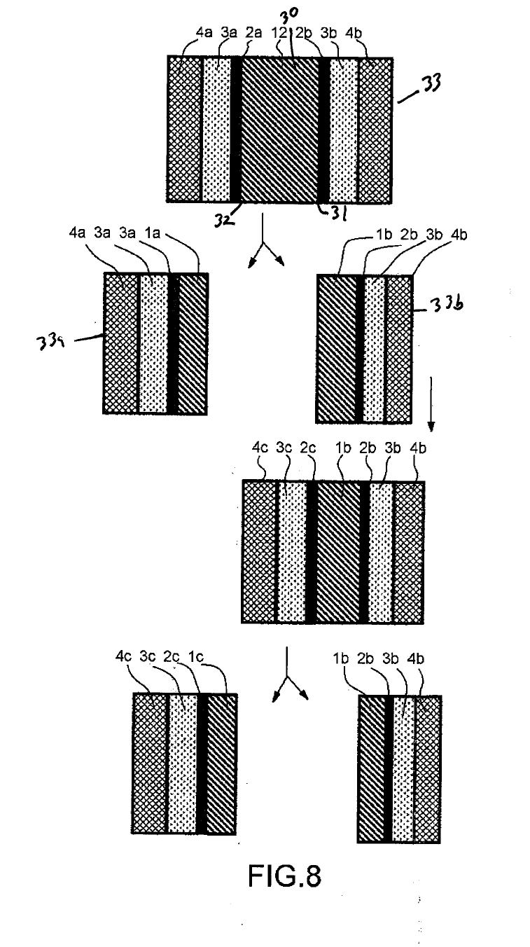

Referring to FIG. 8, production of the flooring plate in accordance with this invention consists of the steps set out below.

In step 1, a stone slab is cut into sheets and then cut into rectangular sheets 30 of the desired dimensions for the flooring surface. The rectangular sheets have a top surface 31 and a bottom surface 32. In one embodiment the thickness of the sheet is 20 mm. The reinforcing layer 2 and resilient sheet 3 are cut into the same dimension as the rectangular sheets 30.

In step 2 the rectangular sheets 30 receive an initial sanding. The rectangular sheets 30 are sanded, removing at least 1 mm from the top surface 31 and bottom surface 32, to smooth the surface and prevent trapping of adhesive when bonding the other layers.

In step 3 individual reinforcing layers 2 and 2a are bonded to both the top side 31 and the bottom side 32 of the now 19 mm thick, rectangular sheet 30 from previous step. Subsequently, resilient layers 3 and 3a are bonded to the reinforcing layers 2 and 2a. This has created a double thick composite 33.

In step 4, the double thick composite 33 is cut into the desired flooring thickness. The composite 33 is cut through the rectangular sheet 30 creating two floor sub assemblies 33 a and b each containing a reinforcing layer 2 and a resilient layer 3.

If the rectangular sheet is thick enough, the now exposed faces of the cut rectangular sheet 30 can be bonded to reinforcing layers 2 and resilient layers 3 and the rectangular sheet 30 cut again to produce another sub assembly 33. This process can be repeated as long as the rectangular sheet 30 still has sufficient thickness to allow another cut. The thickness will be limited by the physical properties of the material used and should not be cut so thin that the rectangular layers break during manufacturing.

In step 5 Surface of the marble of resulting subassemblies 33 undergo a second sanding on the stone surface to smooth the surface. Lapping techniques are employed to produce a glossy finish on the flooring face. Preferred end marble thickness ranges from 1.5 mm to 3 mm with an ideal end state marble thickness of around 2.5 mm. After surfaced treatment, the marblealuminum mesh-concrete slab sub-assembly is cut and trimmed into standard dimensions.

In step 6, the sub-assembly 33 is then further processed into a standard thickness, by sanding the resilient layer 3. This process allows the manufacturer to reach the standard overall thickness of the sub-assembly 33 to accommodate varying thickness of the stone layer. In one embodiment, the total thickness of the end flooring product is 10 mm. In an embodiment the sanding processes reduce the marble and resilient layer to a standard thickness of about 2.5 mm and about 3.5 mm, respectively, for a sub-assembly of 6 mm in thickness.

In optional Step 7, a groove 13 designed to receive a heating coil 16 is cut on the cement body using a carpentry router. In a preferred embodiment, the groove is 3.5 mm and 3.3 mm, in depth and width, respectively.

When a heating coil is used, a silicon based electrical insulation is applied on the groove 13 cut on the resilient layer 3 from the previous process and the heating coil 16 is placed in the groove 13 and secured in place with an adhesive. In a preferred embodiment, the adhesive is an epoxy. In the final step, an injection molded proprietary, thermal enhanced plastic layer 4, made from PS (polystyrene) 50%, PPS (polyethylene sulfide) 30%, and Powdered Charcoal 20%, is bonded to the sub-assembly by using adhesives. Careful attachment of the plastic layer 4 to the—sub-assembly 33 is required, because slightest misalignment along the edges will cause gaps between the panels during installation.

In one embodiment, the third layer has an uninterrupted, alternating ‘U’ shaped groove on the top surface opposite of the one facing the second layer. The groove accommodates insertion of the fourth layer, a 3.5 mm thick solid, metal heating coil. Under the fourth layer, a fifth layer, a plastic sheet with a unique joint structure, is attached with an adhesive.

While several embodiments of the invention have been disclosed in the specification, it will be understood by one of skill in the art that other modifications and embodiments are possible without deviating from the spirit of the invention.

I claim:

1. An architectural composite plate comprising:
a) an architectural surface material having a top and bottom surface;
b) a reinforcing layer bonded to the surface material's bottom surface or top surface;
c) a resilient layer bonded to the reinforcing layer
d) a plastic base.

2. The architectural composite place of claim 1, wherein the plate is intended for flooring or cladding a wall.

3. The architectural composite of claim 1 wherein the architectural surface is a stone or a wood.

4. The architectural composite of claim 1 wherein reinforcing layer is a mesh comprising metal or polymer.

5. The architectural composite of claim 1 wherein the resilient layer is an ecoboard or a cement board.

6. The architectural composite of claim 1 wherein the plastic base has at least one tongue on two sides and a groove on at least 2 sides bonded to the resilient layer.

7. The architectural composite of claim 1 wherein the resilient material comprises grooves for containing a heating element.

8. The architectural composite of claim 7 wherein the architectural composite further comprises a heating element.

9. The architectural composite of claim 6 wherein the tongue further comprises a convex projection and the groove further comprises a concave indentation, wherein the concave indentation and the convex projection serve to lock two or more adjacent architectural composites together.

10. A heated composite flooring comprising:
a) an architectural surface material having a top and bottom surface;
b) a reinforcing layer bonded to the surface material's bottom surface or top surface;
c) a resilient layer bonded to the reinforcing layer;
d) a heating element disposed in the resilient layer; and
d) a plastic base.

11. The flooring of claim 10 wherein the heating element is an electric heating element.

12. The flooring of claim 10 wherein the heating element lies in a groove in the resilient layer.

13. The architectural composite of claim 10 wherein the architectural surface is a stone or a wood.

14. The architectural composite of claim 10 wherein reinforcing layer is a mesh comprising metal or polymer.

15. The architectural composite of claim 10 wherein the resilient layer is an ecoboard or a cement board.

16. The architectural composite of claim 9 wherein the plastic base has at least one tongue on two sides and a groove on at least 2 sides bonded to the resilient layer.

17. A method of producing an architectural composite plate material comprising:
a) cutting an architectural surface material to a certain width and length and thickness to create a material having a top and bottom surface;
b) reinforcing the architectural surface material by bonding a reinforcing material of the dimension of the surface material to the surface material's bottom surface or top surface;
c) bonding to the reinforcing material a resilient material
d) reducing the architectural surface material to a desired thickness and surface quality
e) reducing the resilient material to a desired thickness
f) bonding a plastic base to the resilient material.

18. The method of claim 17 wherein the reinforcing material, resilient materials are bonded to each side of the architectural surface material and the architectural surface material is cut to produce a plurality of architectural plates.

19. The method of claim 17 further comprising the resilient material is grooved for receipt of a heating element; and
inserting a heating element.

20. The method of claim 17, wherein after the architectural material is cut additional the reinforcing material, resilient materials are bonded to at least one cut surface and the architectural material is cut again.

21. The method of claim 17 wherein the plastic base contains tongues and grooves for locking the plate material together.

22. The architectural composite of claim 21 wherein the tongue further comprises a convex projection and the groove further comprises a concave indentation, wherein the concave indentation and the convex projection serve to lock two or more adjacent plates together.
